(19) United States
(12) Patent Application Publication
(10) Pub. No.: US 2002/0163433 A1
(43) Pub. Date: Nov. 7, 2002

(54) Powder lacquer coated security elements for securing merchandise and castings or injection moldings containing such elements for protection against pilferage

(75) Inventor: Michael Rapp, Modautal (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Checkpoint Systems International GmbH

(21) Appl. No.: 10/123,818

(22) Filed: Apr. 15, 2002

Related U.S. Application Data
(63) Continuation of application No. PCT/EP00/08697, filed on Sep. 6, 2000.

(30) Foreign Application Priority Data
Oct. 13, 1999 (DE) 199 49 298.0

(51) Int. Cl. G08B 13/14

(52) U.S. Cl. 340/572.3; 340/572.6; 340/572.8; 148/217; 148/240

(57) ABSTRACT

Security elements used to secure goods, as well as castings or injection-molded parts containing such security elements, for protection against theft are encased in a powder lacquer layer. Security elements for protecting goods contain soft magnetic and hard magnetic components. When a magnetic alternating field is applied to the soft magnetic components, they are excited in order to emit a characteristic signal. The hard magnetic components are located on the soft magnetic components in such a way that the hard magnetic components, in their magnetized state, prevent the emission of the characteristic signal of the security element. In order to protect the security elements, in particular against detachment of the soft magnetic components from the hard magnetic components, the security components are at least partially encased in a layer of powder lacquer.

### CROSS-REFERENCE TO RELATED APPLICATIONS

This application is a continuation of International application Ser. No. PCT/EP00/08697, filed Sep. 6, 2000, the disclosure of which is incorporated herein by reference.

### BACKGROUND OF THE INVENTION

This invention is directed to powder lacquer coated security elements for securing merchandise, as well as to castings or injection moldings containing such elements for protection against pilferage.

The individual security elements comprise a magnetic material of high permeability and low coercive force (soft magnetic material) and a magnetic material of low permeability and high coercive force (semi-hard or hard magnetic material). On application of an alternating magnetic field the soft magnetic components are excited into emitting a characteristic signal. This characteristic signal can be suppressed, when the semi-hard or hard magnetic material is in a remanent magnetization state, upon application of an appropriately high magnetic field.

As a rule, the soft magnetic components of the above-described security elements have at least one preferred magnetic axis.

Security elements of the type described above find application preferably in the field of electronic article surveillance in department stores and warehouses.

A particular advantageous embodiment of a security element is known from European Patent EP 0 295 028 B1. This patent describes security elements of the type referred to as thin-film security elements. These elements comprise a thin, preferably in the micron range, layer of a soft magnetic material. The layer is applied to a carrier substrate using, for example, a physical deposition process under vacuum conditions.

Thin-film security elements exhibit an anisotropic structure. Anisotropic means that the soft magnetic layer from which the thin-film security elements are formed possesses a preferred axis. In practice, the anisotropic properties become noticeable in that the characteristic signal emitted by the thin-film security element in response to an interrogation field is at a maximum level, when the interrogation field and the preferred axis are aligned in parallel with each other. In contrast, the signal disappears when the preferred axis and the interrogation field are perpendicular to each other.

A similar behavior is displayed by elements referred to as strip elements, which comprise a strip-shaped soft magnetic material. Here also, the characteristic signal is at a maximum level when the interrogation field and the strip are aligned in parallel with each other, and disappears with a perpendicular orientation. It will be understood that the strip element may also be made of a length of drawn wire. A security element of this type is proposed in German published patent application DE 197 53 500 A1, for example.

To detect security elements in the interrogation zone, a number of different methods are known in the art. By way of example, reference is made to the detection device proposed in European Patent EP 0 123 586 B.

At the present, time security elements of the type mentioned above are typically affixed to the merchandise to be protected as a constituent part of price tags or bar code tags. However, this type of affixing the security elements to the goods has some disadvantages: The frequently manual marking of goods with security elements or with price or bar code tags containing security elements entails high costs. Furthermore, a knowledgeable shoplifter may be able to recognize the security elements on the goods, remove them or neutralize them in some other way.

For these reasons, goods are increasingly being provided with security elements originally at the time of production. In technical jargon this approach is referred to as “source protection”. In this context it is recommended to provide security elements in the interior of the products, so as to be invisible and nearly inaccessible to the shoplifter.

In modern production engineering, injection molding and casting processes are becoming increasingly important. In the manufacture of injection moldings or castings it appears advantageous to introduce the security elements into the injection or casting molds together with the injection molding or casting material. However, the castings or injection moldings in question are generally cast or injection molded at high temperatures. These high temperatures may damage the above-described security elements. Such damage may involve detachment of the hard magnetic from the soft magnetic components. Of course, the use of special chemicals in the casting or injection molding material (for example, the use of inhibitors and activators in the polymerization of plastics) may also result in separation of the different components of the security element.

As a result of these separating processes, the distance increases between the soft magnetic and hard magnetic components in the still soft injection molding or casting material. When the magnetic field necessary for deactivation of the security elements is then applied, the hard magnetic components are duly magnetized. However, on account of the spatial distance produced between the cast soft and hard magnetic components of the security element, the evoked permanent magnetic field of the hard magnetic components is too large to effect a further reliable suppression of the emission of the characteristic signal.

Furthermore, there is the risk of the manufacturing process being adversely affected by the presence of small loose components of the security element in the injection molding material as a result of the separating processes described, such impairment including, for example, fouled injection nozzles.

This problem occurs also when the security elements, which frequently exist in the form of continuous webs prior to being separated, are coated with a thin, preferably flexible plastic coating. Security elements with a plastic coating are known in the art and are used, among other applications, for electronic surveillance of seeds packaged in small seed bags. In this connection, the security elements are introduced into the seed bags together with the seeds. International patent application publication WO 98/41382 even proposes a method by which individual security strips also have a plastic coating at their respective ends, so that the entire security element is surrounded by plastic material.

Coating the security elements is performed primarily to protect the metal parts of the security element from oxidation, and to protect the secured merchandise from soiling by metal and metal oxide. In the manufacture of these coated security elements the same problems occur as in the manufacture of castings or injection moldings. Particularly when extrusion processes are used for coating the security elements, fouling of the extrusion nozzles by detached components of the security elements is a frequent occurrence.

### BRIEF SUMMARY OF THE INVENTION

It is therefore an object of the present invention to propose security elements of the type mentioned at the outset, which are protected against a detachment of the soft magnetic components from the hard magnetic components. This object is accomplished with security elements which are at least partially coated with a powder lacquer coating.

In this context it is advantageous for the soft magnetic components of the security elements to be in the form of a foil or strip material.

The use of powder lacquers containing metal powder, for example steel powder, has proven to be of particular advantage.

As mentioned at the outset, castings or injection moldings which contain coated security elements afford great advantages in the protection of merchandise against pilferage, because of the possibility for the security elements to be introduced directly into the casting or injection molding material, so that the security element is neither visible nor accessible to a shoplifter.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1a is a longitudinal sectional view, along the line 1a-1a of FIG. 1c, of a deactivatable, foil-shaped security element whose soft magnetic components are implemented in foil form;

FIG. 1b is a side view of the security element of FIG. 1a;

FIG. 1c is a top plan view of the security element of FIG. 1a;

FIG. 2a is a side view of a deactivatable strip-shaped security element whose soft magnetic components are implemented in strip form;

FIG. 2b is a top plan view of the security element of FIG. 2a; and

FIG. 3 is a longitudinal sectional view, along the line 3-3 of FIG. 2b, of a security element of the type shown in FIGS. 2a and 2b, now provided with a coating enveloping the security element.

### DETAILED DESCRIPTION OF THE INVENTION

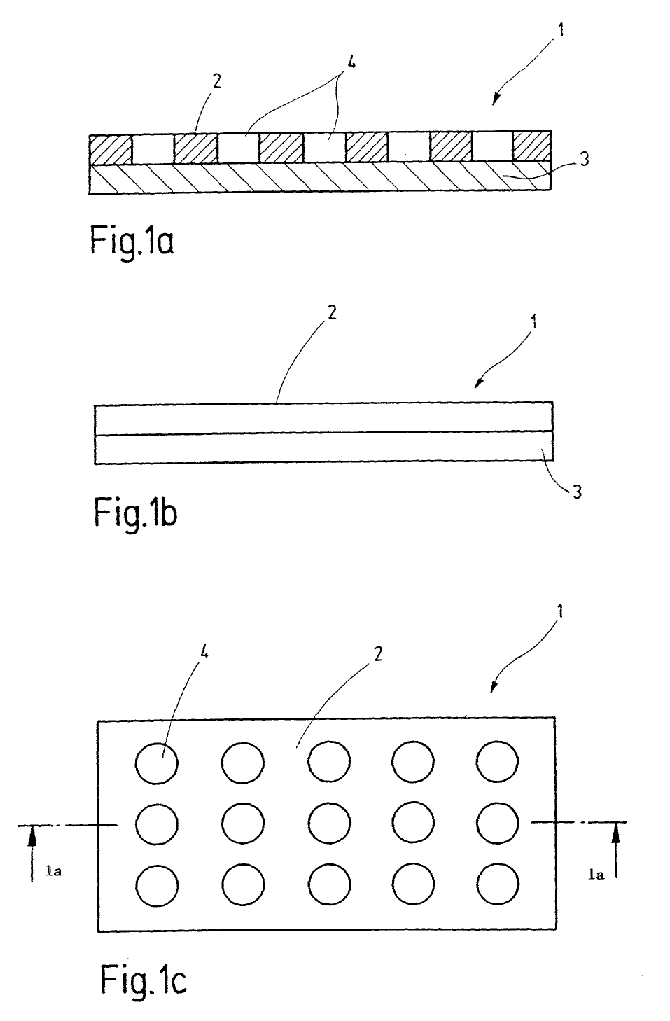

FIG. 1a shows in longitudinal section, along the line 1a-1a, a deactivatable, foil-shaped security element 1, comprising a thin foil 3 of a soft magnetic material. Applied to this foil is a hard magnetic material, for example nickel, which is likewise in foil form. This hard magnetic foil 2 has apertures or holes 4 in a vertical direction, thus being perforated. FIG. 1b shows the same security element 1 in a side view. FIG. 1c shows the foil-shaped security element illustrated in the two preceding Figures in a top plan view of the perforated hard magnetic foil 2. It is to be noted that in all representations of the hard magnetic foil, the holes or apertures 4 are illustrated on an exaggerated scale in comparison with the security element 1 for the sake of clarity of illustration. As a rule, the apertures 4 have a diameter of about 1 to 2 millimeters, while the security element 1 may well cover an area of several square centimeters.

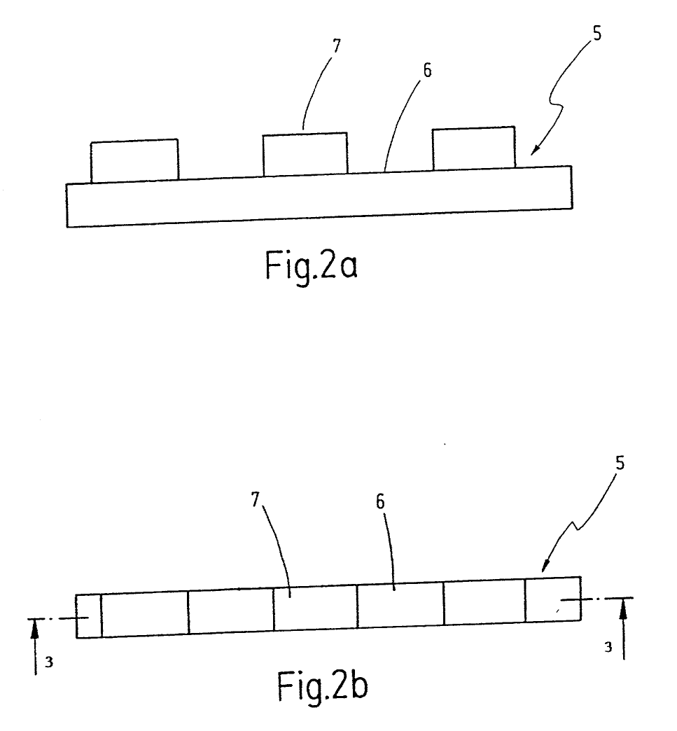

FIG. 2a shows a side view of a deactivatable strip-shaped security element 5. This security element is composed of a soft magnetic strip 6 and hard magnetic sections 7. FIG. 2b shows the same security element in a top plan view.

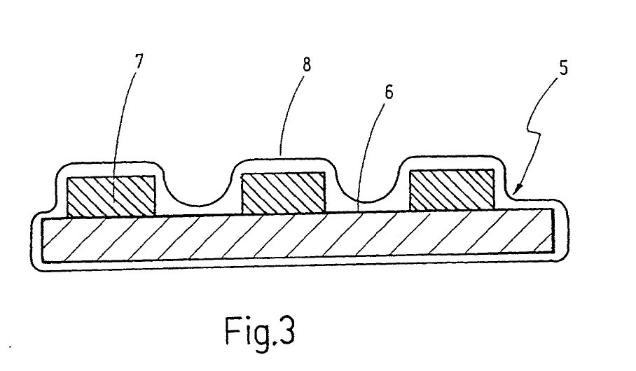

FIG. 3 shows a longitudinal section, along the line 3-3, of a strip-shaped security element 5 of the type illustrated in FIGS. 2a and 2b. However, the security element shown in FIG. 3 is coated with a powder lacquer 8. In addition, the security element 5 coated with the powder coating 8 may be further coated at least partially with a plastic coating (not shown).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A deactivatable security element for protection of articles, the security element (1;5) comprising soft magnetic components (3;6) and hard magnetic components (2;7), the soft magnetic components being excitable into emitting a characteristic signal on application of an alternating magnetic field, and the hard magnetic components being arranged on the soft magnetic components such that the hard magnetic components, in magnetized condition, suppress the emission of the characteristic signal, wherein the security element (1;5) is at least partially coated with a powder lacquer coating (8) which prevents the hard magnetic components (2;7) from separating from the soft magnetic components (3;6) at high temperatures.

2. The deactivatable security element as claimed in claim 1, wherein the soft magnetic components (3;6) have at least one preferred magnetic axis.

3. The deactivatable security element as claimed in claim 2, wherein the soft magnetic components (6) of the security element (5) have a strip-shaped configuration.

4. The deactivatable security element as claimed in claim 2, wherein the soft magnetic components (3) of the security element (1) have a thin foil form.

5. The deactivatable security element as claimed in claim 1, wherein the powder lacquer (8) contains metal powder.

6. The deactivatable security element as claimed in claim 5, wherein the metal powder comprises steel powder.

7. The deactivatable security element as claimed in claim 1, wherein the security element is further at least partially coated with a plastic coating.

8. A casting containing at least one security element (1;5) according to claim 1.

9. An injection molding containing at least one security element (1;5) according to claim 1.
